(19) United States
(12) Patent Application Publication
(10) Pub. No.: US 2015/0193584 A1
(43) Pub. Date: Jul. 9, 2015

(54) SYSTEM AND METHOD FOR CLINICAL PROCEDURE TIMELINE TRACKING

(71) Applicant: The Adrien Group, LLC, Glenwood Springs, CO (US)

(72) Inventors: Frank Laws, Glenwood Springs, CO (US); Abe Khaleghi, Houston, TX (US); Sanjay Parikh, Houston, TX (US); Chris Norton, Houston, TX (US)

(73) Assignee: The Adrien Group, LLC, Glenwood Springs, CO (US)

(21) Appl. No.: 14/147,505

(22) Filed: Jan. 4, 2014

(51) Int. Cl. G06F 19/00

(52) U.S. Cl. CPC G06F 19/3406; G06F 19/322; G06F 19/3487

(57) ABSTRACT

Described herein is system and method for enabling a real-time clinical procedure timeline. In one embodiment, a patient timeline is created based on a pre-existing template. The user interface displays the steps for an admitted patient with a given diagnosis, tracks the time for completion of each step, and allows users to add notes, attach documents, and build reports. Individual medical practices can create custom templates in the system to meet their specific requirements. Multiple methods of accessing and using the system are supported such as mobile devices, motion sensing devices, optical head-mounted displays, etc.

### CROSS-REFERENCE TO RELATED APPLICATIONS

Not Applicable

### STATEMENT REGARDING FEDERALLY SPONSORED RESEARCH OR DEVELOPMENT

Not Applicable

### BACKGROUND OF THE INVENTION

1. Technical Field

Embodiments of the invention relates to clinical informatics and a clinical informatics platform for health care. Example embodiments of the present invention include receiving real-time updates of the status in medical procedures and creating a timeline of the entire process.

2. Background

Thousands of medical diagnoses and procedures are performed in hospitals and urgent care centers daily. Many of those procedures have a vastly improved success rate when tasks are performed expeditiously. An example of this is a patient that is diagnosed with an ischemic stroke and may be a candidate for tPA treatment; such treatment must be administered generally within 3 hours of the onset of symptoms, therefore speed of completing the required tasks of patient admitting, testing, and diagnosis is critical to the treatment and probable success of patient recovery. Another example of critical timing in patient care is cardiac catheterization. Again, managing and reducing the time from diagnosis to treatment is directly related to increased recovery rates.

Another key component in the timeline of clinical procedures is the end result, or “scoring”, meaning the average time it takes from admission to final task. The faster time, or more efficient total time relates directly to improved patient care, and provides a metric for a healthcare organization to improve, and a metric for insurance companies, government health organizations, and patients.

A variety of computer-based solutions have been developed to assist clinicians in the care of patients. Such solutions provide clinicians diagnostic information and allow clinicians to manage patient activities. However, many of these solutions have not been well constructed. In particular, some solutions present too much information to the clinician, forcing the clinician to sift through the data to find desired information. This can be a time-consuming process for clinicians. As a result, many clinicians resort to a manual process of recording the most vital patient information, for example, on a note card that they carry around with them.

Additionally, above-mentioned systems do not promote real-time communication of the status of medical procedures. Typical systems consist of hand-written notes taken by the medical personnel during the procedure, which are then entered into a computer system later in the day.

To increase the efficiency of multiple step procedures, real-time communication is needed to provide alerts and notifications, and reduce the lag time between tasks in a procedure. Thus, there is a need in the art for a system of intra-clinic communication that would deliver real-time status updates. Specifically, there is a need for a system that is able to inform clinic personnel what steps are in process during a medical procedure. It is to these ends that the present invention has been developed.

### Definitions

Portable Computing Device, Mobile Computing Device, Mobile Communications Device: Mobile computing is a form of human-computer interaction by which a computer is expected to be transported during normal usage. Portable Computing Device, Mobile Computing Device, and Mobile Communications Device shall have the same meaning in the specifications and claims. Mobile computing has three aspects: mobile communication, mobile hardware, and mobile software. The first aspect addresses communication issues in ad-hoc and infrastructure networks as well as communication properties, protocols, data formats and concrete technologies. The second aspect is on the hardware, e.g., mobile devices or device components. The third aspect deals with the characteristics and requirements of mobile applications.

Many types of mobile computers have been introduced since the 1990s including the:
a. Wearable computer
b. Personal digital assistant/enterprise digital assistant
c. Smartphone
d. Carputer
e. Ultra-Mobile PC
f. Tablet computer
g. A watch or glasses with broadband access, touch screen technology, capability to run custom applications, capability to send or receive messages or signals, or any combination thereof.

Mobile Computing Device or Mobile Communications Device: For the purposes of this document, “mobile computing device” or “mobile communications device” shall mean any remote device that is portable and has either phone, computing, or internet access capability, including but not limited to: a smartphone, or any mobile, cellular, PDA, or portable device or portable computing device as previously defined.

Augmented Reality Devices: Augmented reality (AR) is a live, direct or indirect, view of a physical, real-world environment whose elements are augmented (or supplemented) by computer-generated sensory input such as sound, video, graphics or GPS data. It is related to a more general concept called mediated reality, in which a view of reality is modified (possibly even diminished rather than augmented) by a computer. As a result, the technology functions by enhancing one's current perception of reality. By contrast, virtual reality replaces the real world with a simulated one. Augmentation is conventionally in real-time and in semantic context with environmental elements, such as sports scores on TV during a match. With the help of advanced AR technology (e.g. adding computer vision and object recognition) the information about the surrounding real world of the user becomes interactive and digitally manipulable. Artificial information about the environment and its objects can be overlaid on the real world.

Speech Recognition Devices: In computer science, speech recognition (SR) is the translation of spoken words into text. It is also known as “automatic speech recognition”, “ASR”, “computer speech recognition”, “speech to text”, or just “STT”.
1) Some SR systems use “speaker independent speech recognition” while others use “training” where an individual speaker reads sections of text into the SR system. These systems analyze the person's specific voice and use it to fine tune the recognition of that person's speech, resulting in more accurate transcription. Systems that do not use training are called “speaker independent” systems. Systems that use training are called “speaker dependent” systems.

Voice Actions are a series of spoken commands that a computing device using voice

Motion Sensing Devices: Motion detection is the process of detecting a change in position of an object relative to its surroundings or the change in the surroundings relative to an object. Motion detection can be achieved by both mechanical and electronic methods. When motion detection is accomplished by natural organisms, it is called motion perception.

Motion can be detected by:
a) Infrared (Passive and active sensors)
b) Optics (video and camera systems)
c) Radio Frequency Energy (radar, microwave and tomographic motion detection)
d) Sound (microphones and acoustic sensors)
e) Vibration (triboelectric, seismic, and inertia-switch sensors)
f) Magnetism (magnetic sensors and magnetometers)

Optical Head-Mounted Display (OHMD): Optical head-mounted display (OHMD) is a wearable display that has the capability of reflecting projected images as well as allowing the user to optically see-through it. Head Mounted Displays have been used in various forms to assist surgeons and other medical personnel to support and improve visualization of the work site. Historically, many of these were of inadequate resolution, bulky, cave-like and heavy and they, deservedly, received limited acceptance. Recent availability of high-resolution displays, lighter structures and the various see-though designs that merge both real world and registered synthetic imagery have significantly increased the benefits of these devices for the medical community.

A Gesture is a touch or movement on a computing or mobile device that operates as commands to the device or to software on the device. On touchscreen displays, multi-touch refers to the ability to simultaneously register three or more distinct positions of input touches. It is often used to describe other, more limited implementations, like Gesture-Enhanced Single-Touch, Dual-Touch or real Multi-Touch. The interaction of touch and movement on surfaces is a function on electronic visual displays and touchpad pointing devices to interact with content. It is an intermediary connection and detection method from hardware to computer software, to enact a user's intention.

Air Gestures: An Air Gesture is similar to a Gesture as defined above, except that there is no contact required on a touch screen display on a mobile device. An Air Gesture is able to use a screen on a mobile device or portable computing device without direct contact, and can perform all of the same functions performed by Gestures.

Voice Actions are a series of spoken commands that lets a user control a computing device using his voice

Java Script: JavaScript (JS) is an interpreted computer programming language. As part of web browsers, implementations allow client-side scripts to interact with the user, control the browser, communicate asynchronously, and alter the document content that is displayed. It has also become common in server-side programming, game development and the creation of desktop applications.

### SUMMARY OF THE INVENTION

One embodiment of the present invention comprises a system and method adapted to provide intra-clinic communication that delivers real-time status updates to inform clinicians what steps are in process during a medical procedure. The embodiment may be adapted to provide a system and method for the medical personnel to share an application that tracks the steps and timeline of a patient procedure.

Another embodiment of the invention may comprise medical clinicians creating patient timelines using an application user interface on various devices. The application is used by one or more clinicians to track each step in a process, informs users about the progress through the steps, and alerts the next clinicians needed in each step. Users may attach documents to the patient timeline for the purposes of archiving relevant documentation of medical procedures; various file types may be attached, including images, videos, audio files, patient chart files, and any other file type.

Another embodiment of the invention may comprise enabling users to compile and create statistical reports about the medical procedures. Reports can be created from software supplied report templates, or users can create custom reports. Reports are used to analyze the overall timeline of procedures, determine where times or tasks are slow and may be improved, and measure the effectiveness of individual clinicians or administrative staff. Furthermore, users may create custom timeline templates. Medical practices using the system have the flexibility to create custom templates or modify provided templates to customize to their own procedure tasks. Templates are stored either on the practices local server or on the cloud based host server.

Another embodiment of the invention may comprise a cloud based service operating the system, and medical practices that use the system need only to use their own input devices without the need to install any software on their own local network.

Another embodiment of the invention may comprise providing a graphical user interface and method of input for various types of devices used in the medical field. All mobile computing devices may be used, as well as optical head-mounted display (OHMD), motion sensing devices, voice recognition devices, and augmented reality devices. Any input method supported by the individual device may be used, including keyboard, touchscreen, voice commands, air gestures, and other methods that are used by the individual device. Each individual device type or device may allow for attaching video files, audio files, or other files that will be attached to and become a permanent part of the patient medical record.

### BRIEF DESCRIPTION OF THE DRAWINGS

The above and other objects, features, and advantages of the embodiments of the present invention are further described in the detailed description which follows, with reference to the drawings by way of non-limiting exemplary embodiments of the present invention, wherein like reference numerals represent similar parts of the present invention throughout the several views and wherein:

FIG. 1 illustrates a patient timeline tracking system according to one embodiment of the invention. A mobile computing device may request data from a cloud-based host server; data is returned formatted in a device client user interface.

FIG. 2 illustrates a patient timeline tracking according to another embodiment of the invention. A mobile computing device may request data from a local server; data is returned formatted in a device client user interface.

FIG. 3 illustrates a flowchart that depicts a method that may be carried out in connection with the embodiments described herein.

FIG. 4 illustrates various input methods that may be used according to one embodiment of the invention.

FIG. 5 illustrates a patient timeline tracking system according to one embodiment of the invention. Various supported devices may input and receive related to the patient timeline.

FIG. 6 illustrates a flowchart that depicts a method that may be carried out in connection with the embodiments described herein.

FIG. 7 illustrates a sample user interface on a mobile computing device that may be carried out in connection with the embodiments described herein.

FIG. 8 illustrates a sample user interface on a mobile computing device that may be carried out in connection with the embodiments described herein.

### DETAILED DESCRIPTION OF THE INVENTION

Although the detailed description herein contains many specifics for the purposes of illustration, anyone of ordinary skill in the art will appreciate that many variations and alterations to the following details are within the scope of the embodiments described herein. Thus, the following illustrative embodiments are set forth without any loss of generality to, and without imposing limitations upon, the claimed invention.

In various embodiments, a system, method and non-transitory, tangible, computer readable storage medium are adapted to provide intra-clinic communication that delivers real-time status updates to inform clinicians what steps are in process during a medical procedure is disclosed. The embodiment may be adapted to provide a system and method for the medical personnel to share an application that tracks the steps and timeline of a patient procedure. System components include a server, a database, computing devices, client user interfaces, templates, and a means for computing devices to communicate with the server.

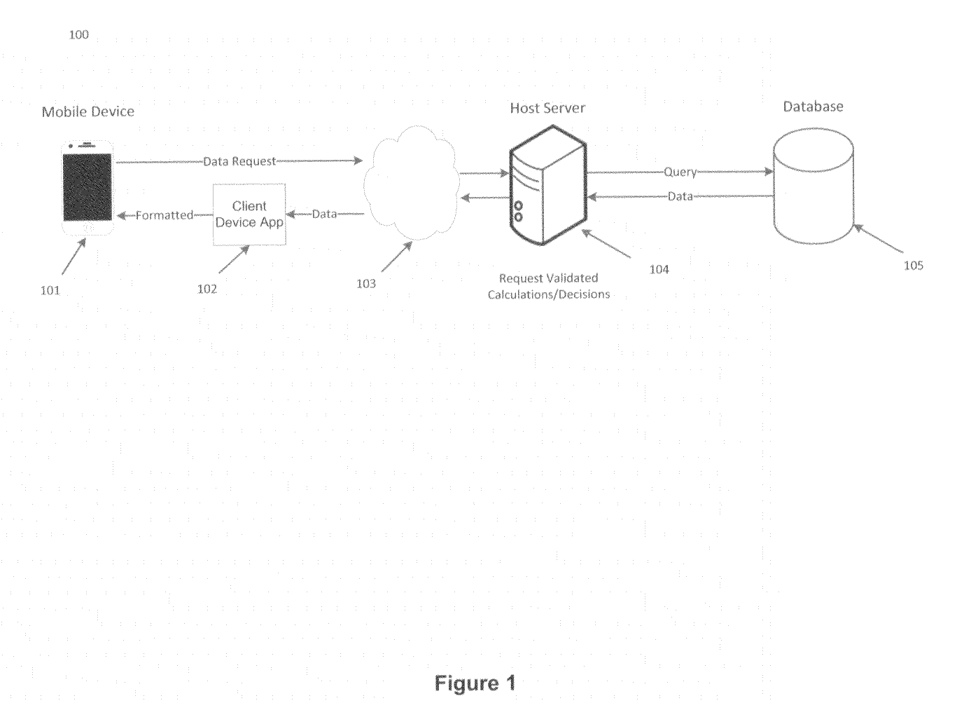

FIG. 1 illustrates one embodiment of the system 100. Clinicians may use a computing device or mobile computing device 101 as shown in this embodiment. The term “clinician” refers to a medical professional that uses the system, and the term “user” will be used herein to refer to a clinician. The user of the mobile device 101 sends a data request over the internet 103 to communicate with the host server 104. It should be appreciated that communications over the internet may be accomplished by wired or wireless means, and alternately a cellular connection may be used. The host server 104 validates the request and processes the data request in the form of a query to the database. It should be appreciated that a distributed file system may be used in place of a database. The database is configured to store clinical procedure data, patient data, attached documents including images, timeline templates, and is operationally coupled to the server.

It should be understood that the system 100 may employ a single powerful server to perform the functions of both the host server 104 and database server 105 or any other portion of the system 100. Alternatively, multiple computers may be employed to provide the server functionality and/or the database server functionality. The host server 104 and database server 105 may reside behind a firewall or other forms of security measures. Data backup servers may be used as well as other data storage services such as cloud servers.

Still referring to FIG. 1, the database 105 sends the requested data to the host server 104. The host server 104 may perform any calculations needed or perform and decisions needed to properly respond to the data request. The host server 104 will then send the requested data to the client device application 102 for formatting and presentation to the client computing device 101 of the user.

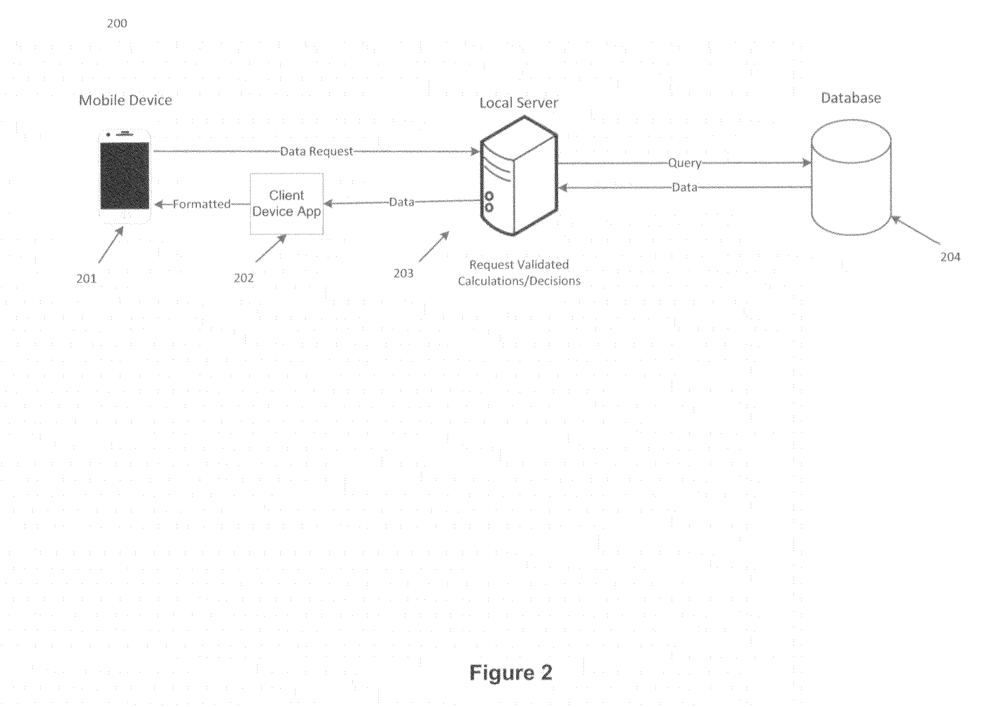

FIG. 2 illustrates an alternate embodiment of the system 200. In this configuration, the main server is a local server 203 that resides within the network of the system user, preferably a medical practice. The user of the mobile device 201 sends a data request over the local network connection to communicate with the local server 203. The local server 203 validates the request and processes the data request in the form of a query to the database. It should be appreciated that a distributed file system may be used in place of a database.

Still referring to FIG. 2, the database 204 sends the requested data to the local server 203. The local server 203 may perform any calculations needed or perform and decisions needed to properly respond to the data request. The local server 203 will then send the requested data to the client device application 202 for formatting and presentation to the client computing device 201 of the user.

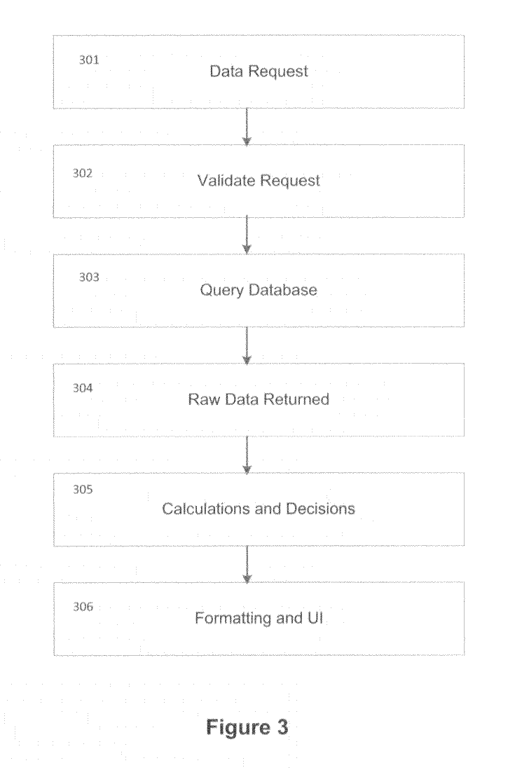

FIG. 3 illustrates the data flow of the patient timeline system. A data request 301 is sent to the server. The request validated 302, and a query sent to the database 303. The database returns raw data 304 to the server; the server performs any calculations or decisions 305 necessary. Finally, the data is formatted and presented by the client device user interface 306.

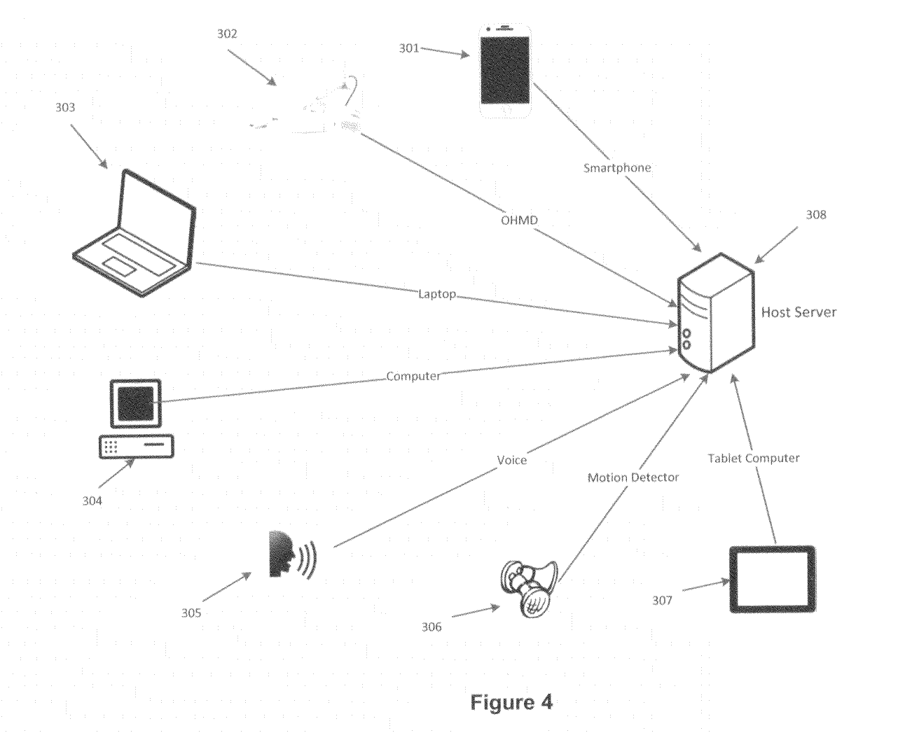

FIG. 4 illustrates the various computing devices and methods that may use the system. It should be understood that one or many devices of any type may be used in one or more procedures as different stages of a procedure typically require different clinical personnel and may be facilitated by the use of different computing devices. Supported computing devices include a personal computer (PC) 304, laptop computer 303, tablet computer 307, and smartphone 301. It should be understood that the devices listed in FIG. 4 are representative of device types and the system is not limited by the devices pictured.

FIG. 4 also illustrates various other types of input methods other than computing and mobile computing devices. An overhead mounted display (OHMD) 302 is a common medical device used in many procedures. The host server 308 may also receive input that triggers a timeline calculation via motion sensor 306, for example, a patient entering a procedure room, or by voice activation 305 by a clinician. It should also be appreciated that one or more of the supported devices may be an augmented reality device.

Many mobile computing devices are controlled via a touchscreen interface. Input and use of the device is by the use of touch gestures on the screen. It should be appreciated that the system client user interface accepts input from touch gestures, and further, from air gestures in the case where the mobile device supports the use of air gestures.

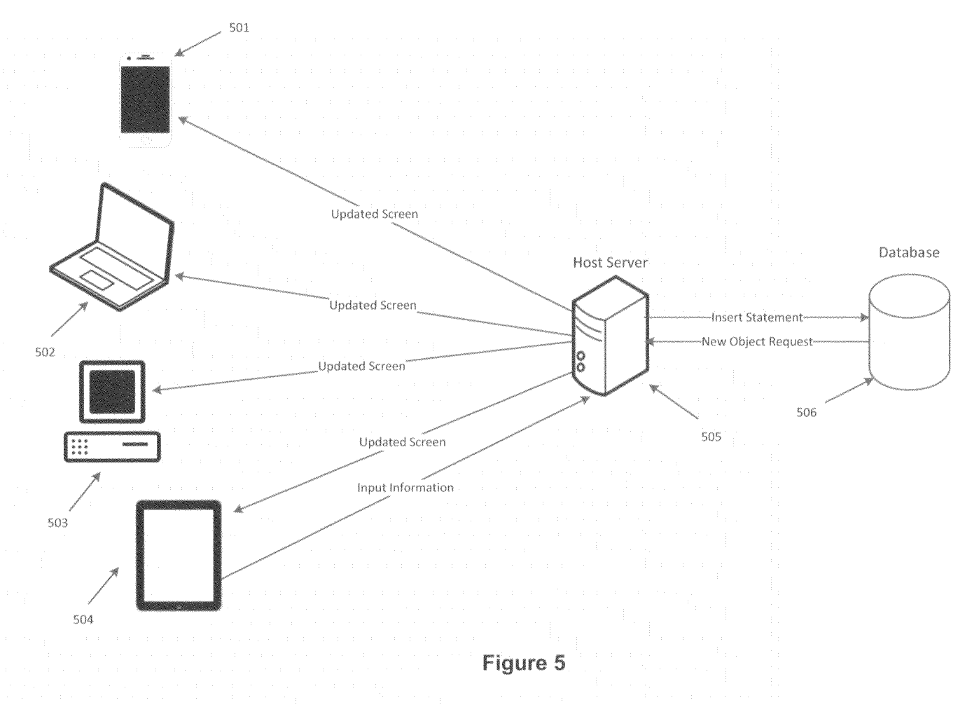

FIG. 5 illustrates the process of sending and receiving real-time updates to patient timelines. The devices represent any device type that can be used with the system, including but not limited to, a smartphone 501, laptop computer 502, personal computer 503, and tablet computer 504. A user completes an update through the custom user interface designed specifically for the device (touch screen, voice command, air gesture, computer input means). Client-side script is used to confirm that data to be submitted is complete and valid. A message indicates if the submission is invalid, otherwise the information is sent to the server 505. The server 505 receives the message and confirms that it is delivered over a secure connection. Server-side script is used to validate the information, and a message indicates if the submission is invalid, otherwise the information is sent to the database 506. An insert or update statement is used to modify the appropriate one or more tables in the database to reflect the changing status of the timeline. The server 505 requests a new object that reflects the updated patient timeline from the database 506. The user interface on the devices (web browser, embedded software, and the like) requests an updated page from the server 505, which reflects the updated information in the database.

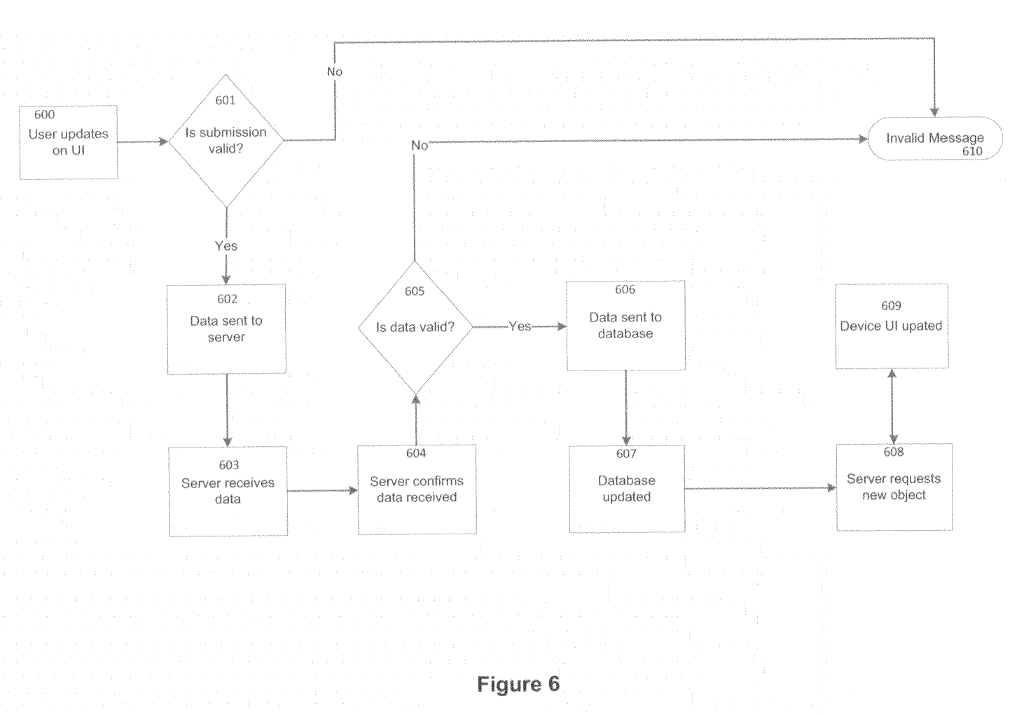

FIG. 6 illustrates a flowchart of one embodiment of the system. A process is started when a user updates the user interface 600 on a device. A client side script confirms that the submission is valid 601. In the case where the submission is invalid, and invalid message 610 is displayed to the user. In the case where the submission is valid, the data is sent to the server 602. The server receives the data 603 and confirms the data is received 604. The server then checks if the data is valid 605. In the case of invalid data, an invalid message 610 is sent back to the user device. In the case of valid data, the data is sent to the database 606, the database is updated 607, the server requests a new object 608, and the server sends the data back to the client device user interface 609.

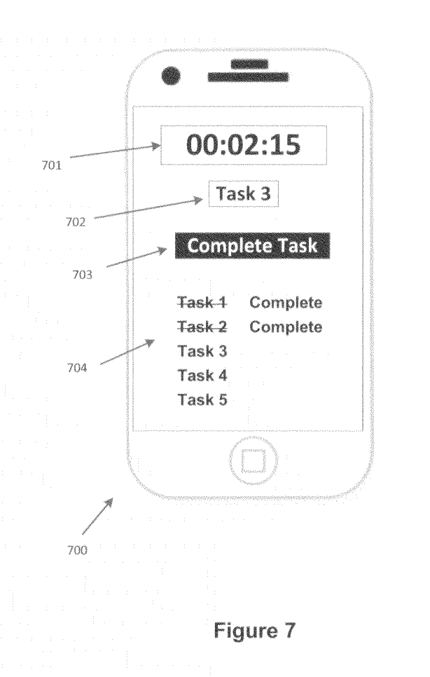

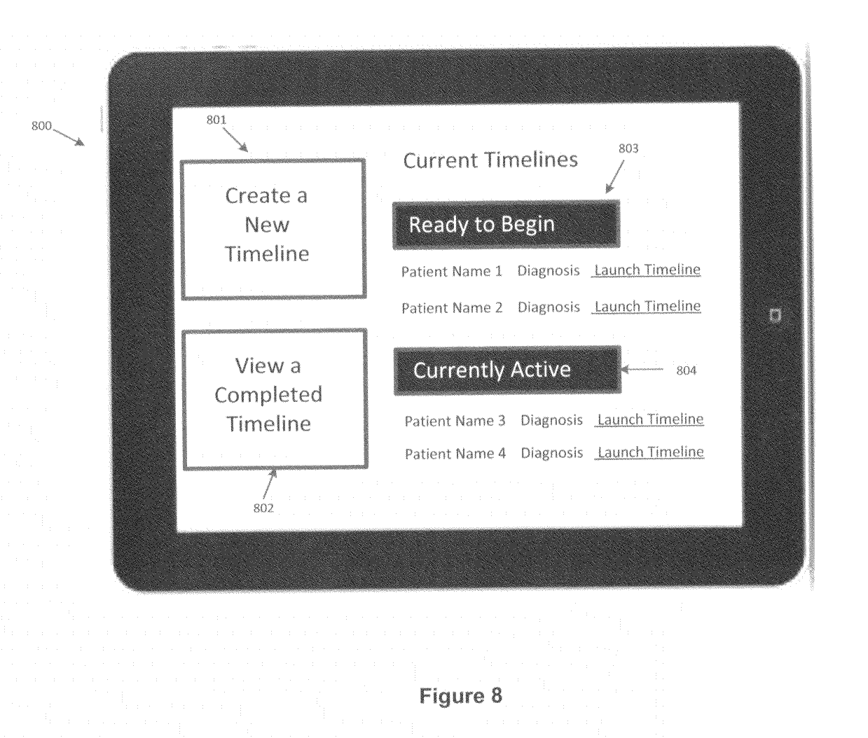

FIGS. 7 and 8 illustrate example client device user interfaces. It should be appreciated that these figures represent some embodiments of the system and are given for sample purposes to show some functions of the system. FIG. 7 is one example of a procedure screen 700. The tasks of a procedure are listed 704, and marked if complete. The current task 703 is displayed, as well as the time in progress 701 of the task. An icon to complete the task 703 is used to alert the system of task completion.

FIG. 8 illustrates another example of a client device user interface. This interface 800 allows a user to view multiple patient timelines. The user may create a new timeline 801 for a new patient or view a complete timeline 802 for past patients. Additionally, the user may begin a new timeline 803 for a new patient, or view currently active patients 804 to see where they are in the procedure process.

It should be appreciated that a user may create custom templates using the system to fit specific procedures or goals, including custom user interfaces. A configuration program is provided for medical practices using the system to have the flexibility to create custom templates or modify provided templates to customize to their own procedure tasks. Templates are stored either on the practices local server or on the cloud based host server.

Reports can be created from software supplied report templates, or users can create custom reports using a supplied configuration program. Reports are used to analyze the overall timeline of procedures, determine where times or tasks are slow and may be improved, and measure the effectiveness of individual clinicians or administrative staff.

1. A system for real-time tracking the timeline of clinical procedures comprising:
a plurality of mobile computing devices, wherein each mobile computing device comprises a user interface configured to:
accept user input,
send data and a request to a server,
receive processed data from the server,
format the processed data,
attach documents, and
display a real-time medical procedure status;
a server configured to:
real-time communicate with plurality of mobile computing devices,
store timeline templates,
complete the real-time validation of user requests,
in response to the request from the user interface, perform a real-time:
query one or more of:
a database, and
a distributed file system,
processing of data received from the plurality of mobile computing devices, and
transmission of the processed data to at least one of the a mobile computing devices;
one of a:
database, and
distributed file system, wherein, the one of a database and distributed file system is configured to store:
the raw and processed data,
the clinical procedure data,
the patient data, and
attached documents;
a template module comprising:
templates of clinical procedure timelines, and
a configuration program for a user to build one or more custom templates of clinical procedure timelines;
a report module configured to generate one or more reports of a clinical procedure timeline;
a configuration program for a user to build one or more custom reports of clinical procedure timelines; and
one or more input devices configured to communicate with at least one of the server and the plurality of mobile computing devices, the one or more input devices comprising one or more of:
personal computers,
mobile computing devices,
optical head mounted display device,
voice recognition devices,
motion sensing devices, and
augmented reality devices.

2. The system as described in claim 1, wherein the server further comprises the capability to:
communicate bi-directionally with one or more input devices over one or more of the following:
local area network,
wired internet means,
wireless internet means,
and cellular means;
validate user requests;
query one or more of:
a database, and
a distributed file system;
receive raw data from the one or more of a:
database, and
distributed file system; and
further perform one or more of the following on the received raw data:
perform calculations,
make logical decisions, and
transmit the data to one or more mobile device client user interfaces.

3. The system as described in claim 1, wherein the one of a database and distributed file system are:
further configured to store the templates of clinical procedure timelines; and
operationally coupled to the server.

4. The system as described in claim 1, wherein the user interface further comprises the capability to:
accept user input by one or more of the following:
keyboard,
mouse,
touchscreen,
air gestures, and
voice commands;
send data to the server;
receive data from the server, and
send to the server one or more of:
documents,
notes,
audio files,
image files, and
video files.

5. The system as described in claim 1, wherein:
the configuration program is further adapted to modify one or more exiting templates; and
the template module is adapted to provide the:
templates of clinical procedure timelines, and
configuration program.

6. The system as described in claim 1, wherein the report module is further configured:
provide templates of clinical procedure reports, wherein the clinical procedure reports summarize any data related to the clinical procedure timeline; and
enable a user to one or more of:
modify one or more templates, and
build one or more of the custom reports of clinical procedure timelines.

7. The system as described in claim 1 wherein the one or more input devices:
communicate bi-directionally with one or more other input devices over one or more of the following:
local area network,
wired internet means,
wireless internet means, and
cellular means; and
are operationally coupled to the server.

8. A method for the real-time tracking the timeline of clinical procedures comprising:
accepting user input on a mobile computing device user interface to:
send a real-time request to a server,
receive a real-time response from the server, the response comprising data,
format the data in real-time upon receipt, and
attach documents to the data;
storing one or more clinical procedure timeline templates on the server;
validating user requests on the server in real-time;
querying in real-time one or more of a:
database, and
distributed file system;
processing raw data in real-time;
transmitting the raw data in real-time;
storing in real-time one or more of:
clinical procedure data,
patient data, and
attached documents;
selecting at least one of the one or more a clinical procedure timeline templates;
and building a custom clinical procedure timeline template;
selecting a clinical procedure report type;
building a custom report using a report configuration program;
communicating with one or more input devices, wherein the one or more input devices comprise one or more of:
personal computers,
mobile computing devices,
optical head mounted display device,
voice recognition devices,
motion sensing devices, and
augmented reality devices.

9. The method as described in claim 8, further comprising the steps of: wherein:
communicating with one or more input devices comprises communicating bi-directionally with one or more input devices over one or more of the following:
local area network,
wired internet means,
wireless internet means, and
cellular means; and further comprising:
receiving the raw data from the one or more of a:
database, and
distributed file system; and
using the raw data to at least one of:
perform calculations,
make logical decisions, and
transmit the data to one or more mobile device client user interfaces.

10. The method as described in claim 8, further comprising:
storing timeline templates; and
operationally coupled the one or more of a database and a distributed file system to the server.

11. The method as described in claim 8, further comprising:
accepting user input on the user interface through one or more of the following:
keyboard,
mouse,
touchscreen,
air gestures, and
voice commands;
sending data to the server; and
sending to the server one or more of:
documents,
notes,
audio files,
image files, and
video files.

12. The method as described in claim 8, further comprising:
providing templates of clinical procedure timelines prior to storing the one or more clinical procedure timeline templates;
providing a configuration program prior to building a custom clinical procedure timeline template; and wherein, building a custime clinical procedure timeline template comprises modifying one or more existing templates.

13. The method as described in claim 8, further comprising:
providing templates of reports summarizing data collected of a clinical procedure timeline prior to selecting a clinical procedure report; and wherein, building a custom report using a report configuration program comprises modifying one or more existing report templates.

14. The method as described in claim 8, further comprising :
communicating bi-directionally with one or more of the input devices;
communicating bi-directionally with one or more input devices comprises using one or more of a:
local area network,
wired internet means,
wireless internet means, and
cellular means; and wherein,
the one or more of the local area network, wired internet means, wireless internet means, and cellular means are operationally coupled to the server.

15. A non-transitory, tangible, computer readable storage medium, encoded with processor readable instructions to perform a method of operating a clinical procedure timeline in real-time relative to when the procedure steps are completed on the patient, the method comprising:
operating a user interface on a mobile computing device by:
accepting user input,
sending a request to a server,
receiving data from the server in real-time,
formatting the received data in real-time, and
attaching documents,
sending communications between the server and one or more mobile computing devices in real-time;
storing timeline templates;
validating user requests in real-time;
querying in real-time one or more of:
a database, and
a distributed file system;
processing raw data in real-time;
transmitting data to one or more mobile devices client user interface in real-time;
storing one or more of:
clinical procedure data,
patient data, and
attached documents;
selecting a clinical procedure timeline template;
building a custom clinical procedure timeline template;
selecting one or more reports;
building a custom report using a report configuration program;
communicating with one or more input devices comprising one or more of:
personal computers,
mobile computing devices,
optical head mounted display device,
voice recognition devices,
motion sensing devices, and
augmented reality devices.

16. The non-transitory, tangible, computer readable storage medium as described in claim 15 wherein:
communicating with one or more input devices comprises communicating:
bi-directionally with one or more input devices operationally coupled to the server, and
over one or more of:
local area network,
wired internet means,
wireless internet means, and
cellular means; and further comprising:
receiving the raw data prior to processing raw data, wherein the raw data is received from the one or more of, the database and the distributed file system; and
further performing on the received raw data one or more of:
performing calculations,
making logical decisions, and
transmitting data to one or more mobile device client user interfaces.

17. The non-transitory, tangible, computer readable storage medium as described in claim 15 wherein:
one of a database, and distributed file system is operationally coupled to the server and further comprising:
storing timeline templates after transmitting data to one or more mobile devices client user interface.

18. The non-transitory, tangible, computer readable storage medium as described in claim 15 wherein:
the user interface accepting user input by one or more of the following:
keyboard,
mouse,
touchscreen,
air gestures, and
voice commands; further comprising:
sending data to the server before processing raw data, wherein the data comprises one or more of, documents, notes, audio files, image files, and video files to the server.

19. The non-transitory, tangible, computer readable storage medium as described in claim 15 further comprising:
providing templates of clinical procedure timelines prior to selecting a clinical procedure timeline template;
providing a configuration program prior to building a custom clinical procedure timeline template, wherein the configuration program enables a user to one or more of:
modify one or more existing templates, and
build one or more custom templates of clinical procedure timelines.

20. The non-transitory, tangible, computer readable storage medium as described in claim 15 further comprising:
providing templates of reports summarizing data collected of a clinical procedure timeline prior to selecting one or more reports;
enabling a user to one or more of:
modify one or more existing report templates, and
build one or more custom reports of clinical procedure timelines.
